(19) United States
(12) Patent Application Publication
(10) Pub. No.: US 2005/0135705 A1
(43) Pub. Date: Jun. 23, 2005

(54) Image forming apparatus

(75) Inventor: Takayuki Nishi, Fujisawa-shi (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/738,170

(22) Filed: Dec. 18, 2003

(51) Int. Cl. G06K 9/36

(52) U.S. Cl. 382/276

(57) ABSTRACT

Key information for encrypting data for image formation stored in a hard disk drive 26, is divided into a plurality of portions and these divided key codes are stored in NVRAMs on various kinds of control boards. In a case where the data is written to or read from the hard disk drive 26, the key information stored in the divided state is collected from the respective NVRAMs, key information in the complete state is created and then the data for image formation is encrypted or decoded by the created key information in the complete state.

### BACKGROUND OF THE INVENTION

1. Field of the Invention

This invention relates to an image forming apparatus such as a digital copying machine that temporarily stores, for example, image data read by a scanner or image data received from an external device in a storage device such as a hard disk and performs an image forming processing on the basis of the image data stored in the storage device.

2. Description of the Related Art

In an image forming apparatus such as a digital copying machine of the prior art, image data read by a scanner or image data received from an external device are temporarily stored in a storage device such as a hard disk and an image forming processing is performed to a medium to form an image on the basis of the image data stored in the hard disk. In such an image forming apparatus, in order to prevent the data stored in the storage device such as a hard disk from being stolen, the data is encrypted and stored in the storage device. Moreover, in the above-described image forming apparatus, in the case of encrypting the data to be stored in the storage device, an encryption scheme using a key code is used in many cases.

However, in the encryption scheme using a key code, the key code needs to be stored in the image forming apparatus. For this reason, if the key code used for encryption is stored in an easy position in the image forming apparatus, the key code itself is easily analyzed (stolen), so that there is presented a problem that the data stored in the storage device will probably be easily decrypted with ease.

### BRIEF SUMMARY OF THE INVENTION

An object of the present invention is to provide an image forming apparatus and an image forming method capable of preventing data stored in a storage device from being stolen.

According to an aspect of the present invention, there is provided an image forming apparatus for forming an image on a medium to have an image formed thereon on the basis of data for image formation, the image forming apparatus comprising: a plurality of memories which store key information to be used for encrypting the data for image formation in a state where the key information is divided into a plurality of portions; a control section which collects the key information stored in the plurality of memories in the divided state and creates the key information in the complete state; an encryption section which encrypts the data for image formation on the basis of the key information in the complete state created by the control section; a storage device which stores the data for image formation encrypted by the encryption section; and a printer which subjects the encrypted data for image formation stored in the storage device, to a processing of forming an image on the basis of the data decoded by the encryption section.

According to an aspect of the present invention, there is provided an image forming method for use in an image forming apparatus comprising a plurality of memories in which various kinds of control data are stored, a storage device which stores data for image formation, and a printer which performs an image forming processing on the basis of the data for image formation stored in the storage device, the image forming method comprising: determining all of the memories having stored therein key information to be used for encrypting the data in the divided state; collecting the key information in the divided state from all of the memories determined to have stored therein the key information in the divided state; creating key information in the complete state from the key information in the divided state, collected from the plurality of memories; encrypting the data for image formation on the basis of the key information in the complete state which has been created from the key information in the divided state, collected from the plurality of memories, and storing the data for image formation in the storage device; reading and decoding the encrypted data for image formation stored in the storage device, on the basis of the key information in the complete state; and performing an image forming processing on the basis of the date for image formation read from the storage device and decoded.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a general configuration of a digital copying machine as an image forming apparatus.

FIG. 2 is a flow chart for explaining a first setting procedure for a key code at the time of setting up the digital copying machine.

FIG. 3 is a flow chart for explaining a second setting procedure for a key code at the time of setting up the digital copying machine.

FIG. 4 is a flow chart for explaining a procedure of encrypting data in the digital copying machine.

FIG. 5 is a flow chart for explaining a procedure of decoding data in the digital copying machine.

FIG. 6 is a flow chart for explaining a procedure of disposing the digital copying machine.

### DETAILED DESCRIPTION OF THE INVENTION

Embodiments of the present invention will be described with reference to the drawings.

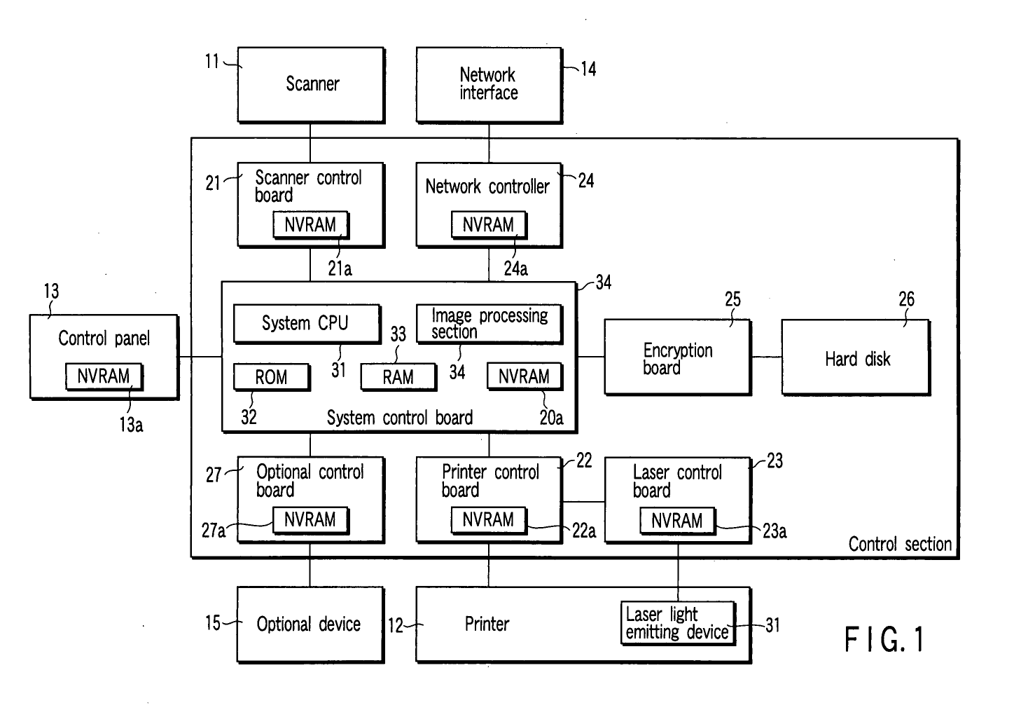

FIG. 1 is a block diagram showing a configuration example of a control section of a digital copying machine 1 in accordance with an image forming apparatus of this invention.

The digital copying machine 1 has a control section 10, a scanner 11, a printer 12, a control panel 13, a network interface 14 and the like. With this configuration, the digital copying machine 1 has various kinds of functions such as image reading processing (scanner function), image forming processing (printer function), communications processing with external devices (network communication function), and copy function. Furthermore, in addition to the configuration described above, the digital copying machine 1 can be mounted with an optional device 15 for realizing various optional functions. The optional devices 15 include, for example, finisher, ADF, facsimile unit, paper feeder of large capacity, multistage paper feeder, hole punching unit, and network expanding unit.

As shown in FIG. 1, the control section 10 of the digital copying machine 1 has a system control board 20, a scanner control board 21, a printer control board 22, a laser control board 23, a printer controller 24, an encryption board 25, a hard disk drive 26 and the like. Moreover, in a case where the digital copying machine 1 is mounted with the above-described optional device 15, it is mounted with an optional control board 27 for controlling the optional device 15.

Each of the system control board 20, the scanner control board 21, the printer control board 22, the laser control board 23, the control panel 13, and the optional control board 27 has at least one of NVRAMs 20a to 24a, 13a, and 27a as a rewritable ROM. Each of the NVRAMs 20a to 24a, 13a, and 27a is configured of, for example, an EEPROM. In each of the NVRAMs 20a to 24a, 13a, and 27a is stored data (software) such as control program necessary for operating each part.

The above-described system control board 20 functions as a system control section that controls the whole copying machine (system) and performs an image processing and stores images.

The system control board 20 is mounted with a system CPU (control section) 31, a ROM 32, a RAM 33, an NVRAM 20a, an image processing part 34, and various kinds of interfaces (not shown). The system CPU 31 controls the whole copying machine on the basis of control programs and control data stored in the ROM 32 or the NVRAM 34.

The scanner control board 21 functions as a scanner control section for controlling the whole scanner 11. The scanner control board 21 as the scanner control section controls an operation of reading an original image, performed by the scanner 11.

The scanner control board 21 is mounted with a scanner CPU (not shown), a ROM (not shown), a RAM (not shown), the NVRAM 21a, a scanner driving and control section (not shown), and an interface (not shown). The above-described scanner CPU controls the scanner 11 on the basis of the control program and control data that are stored in the ROM or the NVRAM 21a and used for controlling the scanner.

The printer control board 22 functions as an engine control section for controlling the whole printer 12. The printer control board 22 as the engine control section drives and controls a main motor and transfer rollers in the printer 12 and prints an image on a medium to form an image.

The printer control board 22 is mounted with a printer CPU (not shown), a ROM (not shown), a RAM (not shown), the NVRAM 22a, an engine driving and control section (not shown), and an interface (not shown). The printer CPU controls the printer 12 on the basis of the control program and control data that are stored in the ROM or the NVRAM 22a and used for controlling the printer.

The laser control board 23 functions as an exposure control section for forming an electrostatic latent image on a photoconductive drum in the printer 12. The laser control board 23 as the exposure control section controls a laser light emitting device 31 and a polygon motor (not shown) in the printer 12.

The laser control board 23 is mounted with a laser control CPU (not shown), a ROM (not shown), a RAM (not shown), the NVRAM 23a, a light emission control section (not shown), and an interface (not shown). The laser control CPU controls the laser light emitting device 31 and the polygon motor on the basis of the control program and control data that are stored in the ROM or the NVRAM 23a and used for controlling exposure.

Here, the laser emitting device 31 emits laser light for forming an electrostatic latent image based on the image data on the photoconductive drum (not shown) as an image carrying body in the printer 12. Moreover, the polygon motor rotates a polygon mirror for guiding the laser light emitted from the laser light emitting device 31 to the photoconductive drum.

The control panel 13 functions as a user interface used when the user operates the copying machine 1.

The control panel 13 is mounted with a panel CPU (not shown), a ROM (not shown), a RAM (not shown), the NVRAM 13a, a display (not shown), an operation key (not shown) and an interface (not shown). The panel control CPU controls a control panel on the basis of the control program, control data and display data that are stored in the ROM or the NVRAM 13a and used for controlling the control panel.

In a case where the digital copying machine 1 is mounted with the optional device 15, it is mounted with an optional control board 27 for controlling the optional device 15. The optional control board 27 functions as an option control section for controlling the optional device 13.

The optional control board 27 is mounted with an option CPU (not shown), a ROM (not shown), a RAM (not shown), the NVRAM 27a, an option driving and control section (not shown), and an interface (not shown). The option CPU controls the optional device 15 on the basis of the control program and control data that are stored in the ROM or the NVRAM 27a and used for controlling the optional device.

Moreover, the encryption board 25 functions as an encryption section for encrypting and decoding data. The encryption board 25 employs an encryption scheme of encrypting and decoding the data by a key code (key information). The key code to be used in the encryption board 25 is given from the system control board 20.

For example, in a case where the image data read by the scanner 11 is stored in the hard disk 26, the encryption board 25 encrypts the image data read by the scanner 11 on the basis of the key code set by the system control board 20 and stores the image data in the hard disk 26. Further, also in a case where the data received from the external device is stored in the hard disk 26, the encryption board 25 encrypts the data received from the external device on the basis of the key code set by the system control board 20 and stores the data in the hard disk 26. Hence, in the hard disk 26 is stored the data encrypted by the encryption board 25.

Further, in a case where the encrypted data stored in the hard disk 26 is read, the encryption board 25 decodes the data stored in the hard disk 26 on the basis of the key code set by the system control board 20 and outputs the data to the system control board 20.

Next, a procedure of setting up the copying machine 1 configured in the manner described above will be described.

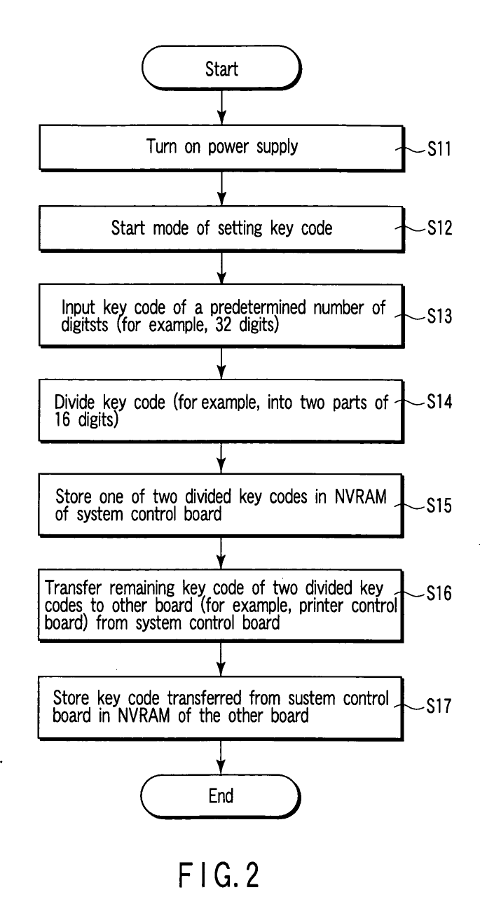

FIG. 2 is a flow chart for explaining a first setting procedure as a procedure of setting the above-described key code at the time of setup (setup mode). Here, in the following description, it is assumed that the setting of the key code is performed at the time of setting up the copying machine by the operation of a serviceman having expertise on the copying machine.

First, a serviceman turns on a power supply switch (not shown) and performs an operation to start a mode (setup mode) for setting a key code by the control panel 13. Then, the system CPU 31 of the system control board 20 turns on the power supply of the copying machine 1 (step S11) and starts a mode of setting a key code (step S12). When the mode of setting a key code, the serviceman inputs a key code by the control panel 13 (step S13). Here, it is assumed that the serviceman inputs a key code of a predeter-mined number of digits (for example, 32 digits).

When the serviceman inputs the key code in the mode of setting a key code, the system CPU 31 of the system control board 20 divides the key code on the basis of a predetermined program stored in the ROM 32 (step S14). For example, the system CPU 31 of the system control board 20 divides the key code of 32 digits into two parts of 16 digits. Here, it is assumed that the key code is divided into two parts by the program previously stored in the ROM 32 and one of the two-divided parts is stored in the NVRAM 20a of the system control board 20 and the other is stored in the NVRAM 22a of the printer control board 22.

That is, when the key code is divided into two parts, the system CPU 31 of the system control board 20 stores one of the key code divided on the basis of the predetermined program stored in the ROM 32 in the NVRAM 20a of the system control board 20 (step S15).

Further, the system CPU 31 of the system control board 20 transfers the remaining key code of the divided key codes on the basis of the predetermined program stored in the ROM 32 to the printer control board 22 as a board to store the key code (step S16).

The printer control board 22 to which the divided key code has been transferred from the system control board 20 receives the key code transferred from the system control board 20 and stores it in the NVRAM 22a on the printer control board 22 (step S17).

Here, it is also recommended that the key code be divided into three or more parts and that the divided key codes be stored in three or more boards. For example, in this first setting procedure, the key code is divided on the basis of the program previously stored in the ROM (program for setting a key code). For this reason, by changing the program previously stored in the ROM, the number of divisions of the key code and boards to store the divided key codes can be arbitrarily set.

In this first setting procedure described above, the key code is divided on the basis of the key code setting program previously stored in the ROM and the divided key codes are stored in NVRAMs of a plurality of boards. With this, according to the first setting procedure, by dividing the key code and storing the divided key codes in the plurality of boards, it is possible to prevent the key code for encrypting the data from being analyzed with ease and hence to provide a copying machine having a high level of security of the data.

Next, a second setting procedure for a key code will be described.

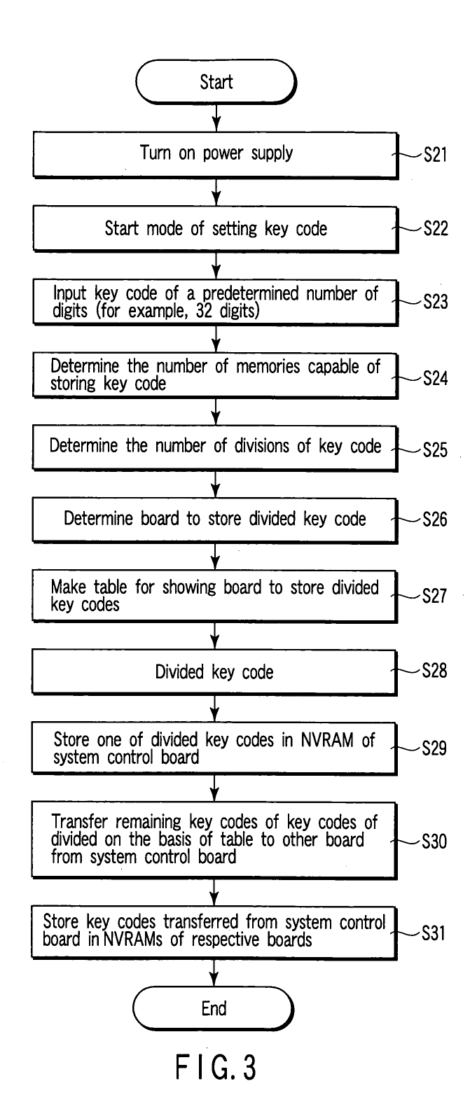

FIG. 3 is a flow chart for explaining the second setting procedure as a procedure of setting the above-described key code at the time of setup (setup mode). Here, in this second setting procedure, it is assumed that a serviceman or a user can select the number of divisions of the key code and boards to store the divided key codes at the time of setting up the copying machine.

First, the serviceman turns on the power supply switch (not shown) and performs an operation to start the mode (setup mode) for setting a key code by the control panel 13. Then, the system CPU 31 of the system board 20 turns on the power supply of the copying machine 1 (step S21) and starts the mode for setting a key code (step S22).

That is, when the mode for setting a key code is started, the serviceman inputs a key code by the control panel 13 (step S23). Here, it is assumed that the serviceman inputs a key code of a predetermined number of digits (for example, 32 digits).

When the serviceman inputs the key code in the mode for setting a key code, the system CPU 31 of the system board 20 determines the number of memories (NVRAMs) capable of storing the key code (step S24). Here, the number of memories capable of storing the key code is determined on the basis of the number of boards having the NVRAMs.

For example, the network controller 24 and the optional control board 27 are selectively provided according to the specifications of the copying machine 1. Hence, in the example of the second setting procedure, the system CPU 31 of the system control board 20 determines the boards having the NVRAMs as memories capable of storing the key code on the basis of the state of connection of the optional device. Here, there is also a possibility that the optional device 13 will be dismounted from the copying machine 1 after the setup. For this reason, it is also recommended that the NVRAM 27a of the optional control board 27 be not accounted as a memory capable of storing the key code.

When the system CPU 31 of the system control board 20 determines the number of memories capable of storing the key code in step S24, the system CPU 31 of the system control board 20 determines the number of divisions of the key code on the basis of the number of memories capable of storing the key code (step S25). Here, the number of divisions of the key code may be any number, if it is within the number of memories capable of storing the key code. For example, the number of divisions of the key code may be the number of memories capable of storing the key code or may be smaller than the number of memories capable of storing the key code.

When the system CPU 31 of the system control board 20 determines the number of divisions of the key code, the system CPU 31 of the system control board 20 determines the boards (NVRAMs) for storing the plurality of divided key codes (step S26). When the system CPU 31 of the system control board 20 determines the boards to store the divided key codes in this manner, the system CPU 31 of the system control board 20 makes a table to show the boards to store the divided key codes (step S27). Here, the above-described table may be stored in the NVRAM 20a on the system control board 20 or a rewritable ROM (not shown).

When the system CPU 31 of the system control board 20 makes the table to show the boards to store the divided key codes, the system CPU 31 of the system control board 20 divides the key code inputted in step S23 into the above-described number of divisions of the key codes (step S28). When the system CPU 31 of the system control board 20 divides the key code, the system CPU 31 of the system control board 20 stores one of the divided key codes in the NVRAM 20a of the system control board 20 (step S29). Here, it is assumed that one of the divided key codes is stored in the NVRAM 20a of the system control board 20.

Further, the system CPU 31 of the system control board 20 transfers the remaining key codes of the divided key codes on the basis of the above-described table to the respective boards to store them (step S30). The respective boards to which the divided key codes have been transferred from the system control board 20 receive the key codes transferred from the system control board 20 and store them in the NVRAMs of the respective boards (step S31).

In the second setting procedure, it is also recommended that the number of divisions of the key code be selected by the serviceman or by the user. For example, the system CPU 31 of the system control board 20 makes the serviceman or the user designate the number of divisions of the key code from the control panel 13 on the condition that the number of memories capable of storing the key codes, determined in step S24, is the upper limit of the number of divisions of the key code. In this case, in step S25, it is assumed that the number of divisions of the key code designated by the user is the number of divisions of the key code.

In the second setting procedure described above, the number of divisions of the key code is determined on the basis of the number of control boards or the like in the copying machine and the divided key codes are stored in the plurality of control boards. Moreover, the table is made that shows the control board to store the divided key codes. With this, according to the second setting procedure described above, the key code can be divided and stored on the basis of the specifications of the copying machine to prevent the key code for encrypting the data from being analyzed with ease. Therefore, a copying machine can be provided that has a high level of security of the data.

Next, an encryption procedure by the above-described key code will be described.

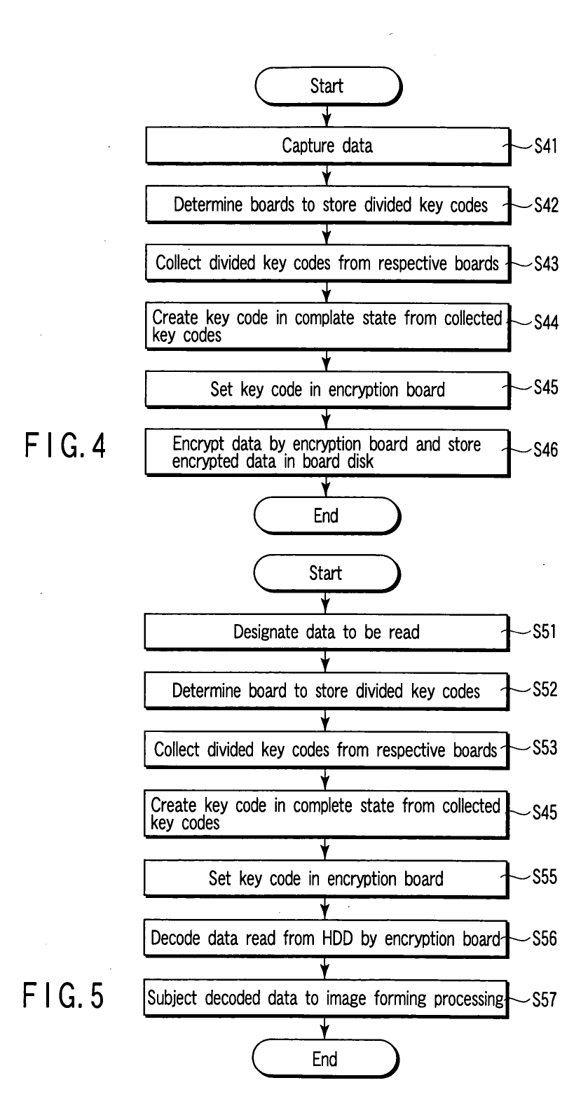

FIG. 4 is a flow chart for explaining a procedure of encrypting and storing data in the hard disk drive 26 of this copying machine 1.

The hard disk 26 of this copying machine 1 is adapted to store the encrypted data. For example, the image data read by the scanner 11 or the data for image formation, which is received from the external device via the network interface 14, is encrypted by the encryption board 25 and is stored in the hard disk drive 26.

That is, when the system control board 20 captures data to be stored in the hard disk drive 26 (step S41), the system CPU 31 of the system control board 20 determines the boards to store the divided key codes (step S42). For example, in a case where the boards to store the key codes are previously determined by the program stored in the ROM, the system CPU 31 of the system control board 20 determines the boards to store the divided key codes on the basis of the predetermined boards to store the key codes. Further, in a case where there is provided a table showing the boards to store the key codes, the system CPU 31 of the system control board 20 determines the boards to store the divided key codes on the basis of the table.

When the system CPU 31 of the system control board 20 determines the boards to store the key codes, the system CPU 31 of the system control board 20 collects the divided key codes stored in the NVRAMs of the respective boards from the respective boards as the boards to store the key codes (step S43). Here, the key codes in the divided state, stored in the NVRAM 20a of the system control board 20, are read from the NVRAM 20a.

When the system CPU 31 of the system control board 20 collects the key codes in the divided state from the respective boards, the system CPU 31 of the system control board 20 develops the key code in the divided state, collected from the respective boards, on the RAM 33 to create a key code in the complete state (step S44).

When the system CPU 31 of the system control board 20 creates the key code in the complete state, the system CPU 31 of the system control board 20 sets the key code in the complete state in the encryption board 25 (step S45). With this, there is brought about a state where the data can be encrypted by the encryption board 25. When the system CPU 31 of the system control board 20 sets the key code in the encryption board 25, the system CPU 31 of the system control board 20 encrypts the data captured in step S41 by the encryption board 25 and stores the encrypted data in the hard disk drive 26 (step S46).

Next, a decoding procedure by the key code will be described.

FIG. 5 is a flow chart for explaining a procedure of reading and decoding the data stored in the hard disk drive 26 of this copying machine 1 and subjecting the decoded data to an image forming processing.

The encrypted data stored in the hard disk drive 26 of this copying machine 1 needs to be read and decoded by the use of the key code. Hence, the system CPU 31 of the system control board 20 needs to set the key code in the encryption board even when the data is read from the hard disk drive 26.

First, when the data is read from the hard disk drive 26, the system CPU 31 of the system control board 20 designates data to be read from the hard disk drive 26 and decoded (step S51)

When the data to be read from the hard disk drive 26 is designated, the system CPU 31 of the system control board 20 determines the boards to store the key codes in the divided state by the same operation as in the steps S42 to S45 (step S52), collects the key codes in the divided state from the respective boards (step S53), creates the key code in the complete state (step S54) and sets the key code in the complete state in the encryption board 25 (step S55).

Here, when the key code in the complete state is already set in the encryption board 25, the processings in steps S52 to S55 are omitted.

The operation like this brings about a state in which the data can be decoded by the encryption board 25. The CPU 31 that sets the key code in the encryption board 25 reads the data designated in the step S51 and decodes the data by the encryption board 25 (step S56).

Further, the system CPU 31 of the system control board 20 sends a print request to the printer control board 22, decodes the data by the encryption board 25, and outputs the data read from the hard disk drive 26 to the printer control board 22. With this, the printer 12 performs an image forming processing on the basis of control performed by the printer control board 22 and the laser control board 23 (step S57).

In the encrypting procedure and the decoding procedure described above, the key codes stored in the divided state in the plurality of boards in the copying machine are collected from the respective boards, the key code in the complete state is created from the key codes in the divided state that are collected from the respective boards, and this key code in the complete state is made a key code for encrypting the data to be stored in the hard disk drive or a key code for decoding the data stored in the hard disk drive. By storing the key code for encrypting and decoding the data in the divided state in this manner, the security of the data can be improved.

In this respect, the image forming processing by the copying machine 1 is realized in the following manner: the image data read by the scanner 11 or the image forming data received from the external device is encrypted and temporarily stored in the hard disk drive 26 (steps S41 to S46 described above) and the data stored in the hard disk drive 26 is read and decoded and printed on copy paper by the printer 12 (steps S51, S56 and S57).

Next, a procedure of disposing the copying machine 1 will be described.

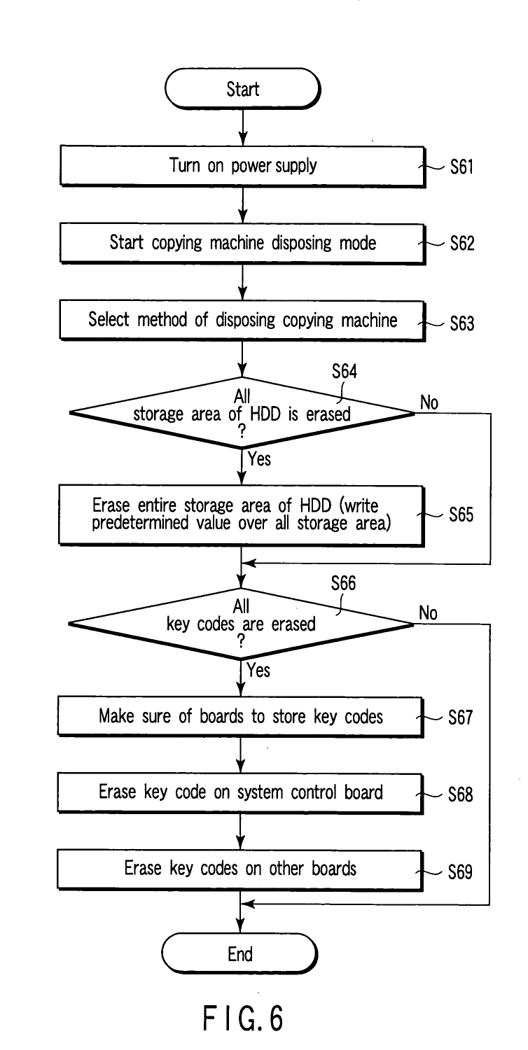

FIG. 6 is a flow chart for explaining the procedure of disposing the copying machine 1. Here, in the following description, it is assumed that an operation of disposing the copying machine 1 is performed by a serviceman having the expertise of copying machine.

First, the serviceman turns on the power supply switch (not shown) and performs an operation of starting a copying machine disposing processing mode for disposing the copying machine by the control panel 13. Then, the system CPU 31 of the system control board 20 turns on the power supply of the copying machine 1 (step S61) and starts the copying machine disposing processing mode (step S62).

When the copying machine disposing mode is started, the serviceman selects and instructs the copying machine disposing mode by the use of the control panel 13 (step S63). Here, the serviceman selects, as a method of disposing the copying machine, for example, whether or not the contents recorded in the hard disk drive 26 are erased, and whether or not the key code are erased.

When the method of disposing the copying machine is selected by the use of the control panel 13, the system CPU 31 of the system control board 20 determines, on the basis of the selected method of disposing the copying machine, whether or not the contents recorded in the hard disk drive 26 are erased (step S64). In a case where the system CPU 31 determines that the contents recorded in the hard disk drive 26 are to be erased (YES in step S64), the system CPU 31 writes a predetermined value over all of the storage area of the hard disk drive 26 (step S65). In general, there is a possibility that the data recorded in the hard disk drive 26 cannot be completely erased by one overwriting operation. For this reason, it is also recommended that the predetermined value be written over the storage area of the hard disk drive 26 for several times.

Further, in a case where the erasing of the key code is selected as the method of disposing the copying machine (YES in step S66), the system CPU 31 of the system control board 20 erases the key codes stored in the divided state in the NVRAMs of the plurality of boards (step S67 to S69).

That is, in the case of erasing the key code, the system CPU 31 of the system control board 20 makes sure of the boards to store the divided key codes (step S67). Here, in a case where the key codes are stored in the boards based on a predetermined program, the system CPU 31 makes sure of the boards based on the predetermined program. Moreover, in a case where a table showing the boards to store the divided key codes, the system CPU 31 makes sure of the boards to store the divided key codes on the basis of the table.

When the system CPU 31 of the system control board 20 makes sure of the boards to store the divided key codes, the system CPU 31 first erases the key code stored in the NVRAM 20a on the system control board 20 (step S68). When the system CPU 31 of the system control board 20 erases the key code stored in the NVRAM 20a on the system control board 20, the system CPU 31 further erases all of the key codes in the divided state that are stored in the NVRAMs on the other boards (step S69). For example, in a case where the divided key code is stored in the NVRAM 22a on the printer control board 22, the system CPU 31 outputs an instruction to erase the key code stored in the NVRAM 22a to the printer control board 22. With this, the printer CPU (not shown) of the printer control board 22 erases the key code stored in the NVRAM 22a.

All of the key codes stored in the plurality of boards are erased in the above steps S67 to S69. Moreover, in general, when data is once erased in the NVRAM, the data is completely erased. In other words, the key codes stored in the NVRAMs in the divided state can be completely erased. For this reason, even if the data stored in the hard disk drive 26 is analyzed after the copying machine is disposed, the key codes are not analyzed and hence the security of the data stored in the hard disk drive 26 in the copying machine can be improved.

As described above, in this copying machine, at the time of setting up the copying machine, the key code for encrypting the data for image formation that is stored in the hard disk drive is divided in the plurality of key codes, and the divided key codes are stored in the plurality of memories mounted on the plurality of boards in the copying machine. Further, in this copying machine, in a case where the data is written to or read from the hard disk drive, the key codes stored in the plurality of memories in the divided state are collected to create the key code in the complete state and the data for image formation is encrypted or decoded by the created key code in the complete state.

With this, even if the whole copying machine or the control board and the hard disk drive are stolen, the key code is hard to analyze. Hence, even if the copying machine is stolen, it is impossible to read the data stored in the hard disk drive.

Furthermore, in the case of disposing the copying machine, not only the data stored in the hard disk drive is erased but also all of the key codes stored in the divided state are erased. With this, even if the disposed copying machine is analyzed, it is impossible to analyze the key code and hence to read the data stored in the hard disk.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An image forming apparatus for forming an image on a medium to have an image formed thereon on the basis of data for image formation, the image forming apparatus comprising:
a plurality of memories which store key information to be used for encrypting the data for image formation in a state where the key information is divided into a plurality of portions;
a control section which collects the key information stored in said plurality of memories in the divided state and creates the key information in the complete state;
an encryption section which encrypts the data for image formation on the basis of the key information in the complete state created by the control section;
a storage device which stores the data for image formation encrypted by the encryption section; and
a printer which subjects the encrypted data for image formation stored in the storage device, to a processing of forming an image on the basis of the data decoded by the encryption section.

2. The image forming apparatus according to claim 1, wherein the image forming apparatus has a plurality of control boards,
said plurality of memories are rewritable nonvolatile memories mounted on said plurality of control boards, and
the control section collects the key information stored in the nonvolatile memories in the divided state from the respective control boards and creates the key information in the complete state.

3. The image forming apparatus according to claim 1, further comprising a table showing which memory stores the divided key information, wherein the control section collects the key information stored in said plurality of memories in the divided state on the basis of the information stored in the table and creates the key information in the complete state.

4. The image forming apparatus according to claim 1, wherein, in a case where key information is inputted in a setup mode of the image forming apparatus, the control section divides the inputted key information and stores the key information in the divided state in said plurality of memories.

5. The image forming apparatus according to claim 4, wherein, in a case where key information is inputted in a setup mode of the image forming apparatus, the control section determines the number of divisions of the key information, divides the inputted key information according to the number of divisions, and stores the key information in the divided state in the respective memory.

6. The image forming apparatus according to claim 4, wherein, in a case where key information is inputted in a setup mode of the image forming apparatus, the control section determines the number of memories which store the key information in the divided state, divides the inputted key information according to the number of memories, and stores the key information in the divided state in the respective memories.

7. The image forming apparatus according to claim 4, wherein, in a case where key information is inputted in a setup mode of the image forming apparatus, the control section further creates a table showing the memories in which the inputted key information is stored in the divided state, and collects the key information stored in said plurality of memories in the divided state on the basis of information stored in the table and creates the key information in the complete state.

8. The image forming apparatus according to claim 1, wherein, in a case where the image forming apparatus is disposed, the control section erases all of the key information stored in the respective memories in the divided state.

9. The image forming apparatus according to claim 1, wherein, in a case where the image forming apparatus is disposed, the control section erases the key information stored in the respective memories and erases all the storage area in the storage device by writing a predetermined value over the storage area at least one time or more.

10. An image forming method for use in an image forming apparatus comprising a plurality of memories in which various kinds of control data are stored, a storage device which stores data for image formation, and a printer which performs an image forming processing on the basis of the data for image formation stored in the storage device, the image forming method comprising:
determining all of the memories having stored therein key information to be used for encrypting the data in the divided state;
collecting the key information in the divided state from all of the memories determined to have stored therein the key information in the divided state;
creating key information in the complete state from the key information in the divided state, collected from said plurality of memories;
encrypting the data for image formation on the basis of the key information in the complete state which has been created from the key information in the divided state, collected from said plurality of memories, and storing the data for image formation in the storage device;
reading and decoding the encrypted data for image formation stored in the storage device, on the basis of the key information in the complete state; and
performing an image forming processing on the basis of the date for image formation read from the storage device and decoded.

11. The image forming method according to claim 10, wherein said plurality of memories are rewritable nonvolatile memories mounted on a plurality of control boards which the image forming apparatus comprises,
the determining all of the memories determines the control boards having the nonvolatile memories having stored therein the key information to be used for encrypting the data in the divided state, and
the collecting the key information stored in the divided state collects the key information in the divided state stored in the nonvolatile memories, from the respective control boards.

12. The image forming method according to claim 10, wherein the image forming apparatus has a table showing which memory stores the divided key information,
the collecting the key information in the divided state collects the key information stored in said plurality of memories in the divided state on the basis of information stored in the table.

13. The image forming method according to claim 10, further comprising, in a case where key information is inputted in a setup mode of the image forming apparatus, dividing the inputted key information and storing the key information in the divided state in said plurality of memories.

14. The image forming method according to claim 13, wherein the storing the key information, in a case where key information is inputted in a setup mode of the image forming apparatus, determines the number of divisions of the key information, divides the inputted key information according to the number of divisions, and stores the key information in the divided state in the respective memories.

15. The image forming method according to claim 13, wherein the storing the key information, in a case where key information is inputted in a setup mode of the image forming apparatus, determines the number of memories which store the key information in the divided state, divides the inputted key information according to the number of memories, and stores the key information in the divided state in the respective memories.

16. The image forming method according to claim 13, further comprising, in a case where the key information is inputted in a setup mode of the image forming apparatus, creating a table showing the memories in which the inputted key information is stored in the divided state.

17. The image forming method according to claim 10, further comprising, in a case where the image forming apparatus is disposed, erasing all of the key information stored in the respective memories in the divided state.

18. The image forming method according to claim 10, further comprising, in a case where the image forming apparatus is disposed, erasing all of the key information stored in the respective memories in the divided state, and erasing all the storage area in the storage device by writing a predetermined value over the storage area at least one time or more.
